(19) United States
(12) Patent Application Publication
(10) Pub. No.: US 2009/0140854 A1
(43) Pub. Date: Jun. 4, 2009

(54) METHOD FOR INTRUSION DETECTION VIA CHANGES IN THE PRESENCE OF SHORT RANGE RF DEVICES

(75) Inventor: Amit Golander, Tel-Aviv (IL)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/950,078

(22) Filed: Dec. 4, 2007

(51) Int. Cl. G08B 21/00

(52) U.S. Cl. 340/540

(57) ABSTRACT

A method for monitoring for radio frequency (RF) signals to determine an unexpected presence, activity, or security threat, the method includes: scanning for RF signals; detecting an RF signal; determining at least one of the following: whether the RF signal is jammed, whether the RF signal is assigned to a device that is forbidden, and whether the RF signal is assigned to a device breaking one or more pre-defined rules; sending a potential threat alert in response to the determining; and wherein the one or more pre-defined rules are held in a database.

### BACKGROUND OF THE INVENTION

1. Field of the Invention

The present invention relates generally to security and surveillance, and more particularly, to a method for monitoring short range radio frequency signals to determine an unexpected presence, illegal activity, or security threat.

2. Description of the Related Art

The continued increase in crime and terrorism has lead to sophisticated methods and systems for monitoring and securing locations, by detecting and tracking movements of people and objects in the vicinity of the location to be secured. Existing security systems utilize video feeds, which are analyzed by people or by computerized systems to recognize suspicious objects, people, and their behavior. For example, a security system may detect a vehicle parked in front of a building that has not moved for a defined period of time, and the system will trigger an alarm to notify security personnel. In a further example, a security system may detect the presence of an individual in a restricted area, and send out notification signals to security personnel.

### SUMMARY OF THE INVENTION

A method for monitoring for radio frequency (RF) signals to determine an unexpected presence, activity, or security threat, the method includes: scanning for RF signals; detecting an RF signal; determining at least one of the following: whether the RF signal is jammed, whether the RF signal is assigned to a device that is forbidden, and whether the RF signal is assigned to a device breaking one or more pre-defined rules; sending a potential threat alert in response to the determining; and wherein the one or more pre-defined rules are held in a database.

### TECHNICAL EFFECTS

As a result of the summarized invention, a solution is technically achieved for a method for monitoring short range radio frequency signals to determine an unexpected presence, illegal activity, or security threat.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system for practicing one or more embodiments of the present invention.

FIG. 2 is a flowchart illustrating a method for monitoring short range radio frequency signals to determine an unexpected presence, illegal activity, or security threat.

The detailed description explains the preferred embodiments of the invention, together with advantages and features, by way of example with reference to the drawings.

### DETAILED DESCRIPTION

Existing versions of sophisticated security systems provide multiple video feeds to security personnel and operators. However, the existing security systems may provide too many video feeds at once, thereby overwhelming security personnel and operators. In addition, video surveillance identification is limited to direct eye contact and visibility conditions, as well as lacking the ability to automatically distinguishing intruding individuals from approved personnel. Existing surveillance systems are also ineffective in detecting small or concealed objects at entry and exit points such as preventing students from concealing knives, guns, and other weapons, border custom officials looking for illicit drugs, and preventing employee theft of confidential data on small storage devices

Short range radio frequency (RF) technologies, such as Bluetooth and radio frequency identification (RFID), continue to grow in usage and are commonly found in daily lives of people. As the price of RFID technology continues to fall, RFID tags are expected to replace barcodes as a means of identification. Retailers, manufacturers, and governments are expected to increasingly incorporate RFID tags in common products such as clothing, shoes, smart cards, identification cards, passports, credit cards, and other consumer products. The incorporation of RFID technology in common consumer products makes these products ELINT detectable. ELINT stands for ELectronic signals INTelligence, and refers to intelligence gathering by use of electronic sensors.

The incorporation of RFID in consumer products and the resultant susceptibility to ELINT has led to privacy issues and concerns. Existing solutions to privacy concerns block out or jam the identification of what the product is, however, the RF signal footprint emitted by the RFID device is still present and ELINT detectable.

Embodiments of the invention utilize various types of ELINT technology to detect short range RF signals, such as RFID and Bluetooth enabled devices to discover, and potentially identify the presence of unexpected individuals, intruders, and threats. Embodiments of the invention take advantage of individuals who inadvertently provide their location or identity by possessing or using an RF emitting device or object. For example, a person who has a shirt with an embedded RF tag may be detected by the security system of an embodiment of the invention. If authorized personnel have RFID tags that are recognized by the system, the authorized personnel are ignored, whereas the person with the unrecognized RFID tag in their shirt may be monitored by a security camera, or set off an alert. The detected RF signal(s) assist in prioritizing which camera displays should be monitored by security personnel.

Embodiments of the invention may utilize RF triangulation to pin point the location of a detected RF emission, and may provide one or more surveillance cameras with the coordinates of the detected RF emission. The ability to perform RF triangulation is provided through a series of RF sensors configured with exciters and detectors positioned throughout the area to be secured or monitored. The RF exciter sends out a series of interrogation signals at various wavelengths to excite passive RFID tags to return a signal. The detector portion of the RF sensor receives emissions from the RFID tag(s), and other devices such as Bluetooth devices. An additional method for locating the position of detected RF emissions is by calculating signal range with a series of antennas. For example, Bluetooth has a range of approximately 1 0 meters with some antennas, while RFID has an even shorter distance, therefore antennas ranging from about 10 meters to about 100 meters may be utilized to gain positional information, with the smaller range antennas providing the best position approximation.

Embodiments of the invention may be placed at checkpoints, entrances/exits, and custom stations to detect concealed items configured with RFID, or items purchased in RFID containers. For example, pharmaceuticals or drugs may be in containers identifiable with RFID technology, or handguns or knives may be configured with RFID technology for tracing and registration purposes.

Embodiments of the invention categorize at least four detected device situations as potential threats. One, new devices with RF emissions, which have not been registered or approved with security. For example, a new shirt worn by an employee with an RFID tag that has not been registered with security may trigger an alarm or prioritize a camera view with the employee. Two, RF emitting devices spotted in irregular patterns, for example an individual appearing to be randomly passing in front of a bank entrance, but spotted by an embodiment of the invention more than a predefined number of instances in a predefined time interval. Three, forbidden device types emitting RF signals that may be concealed such as cameras, drugs, alcohol, or any other family of products. Four, the RFID signal emitted from a detected device is jammed or masked in an attempt to conceal the devices identity.

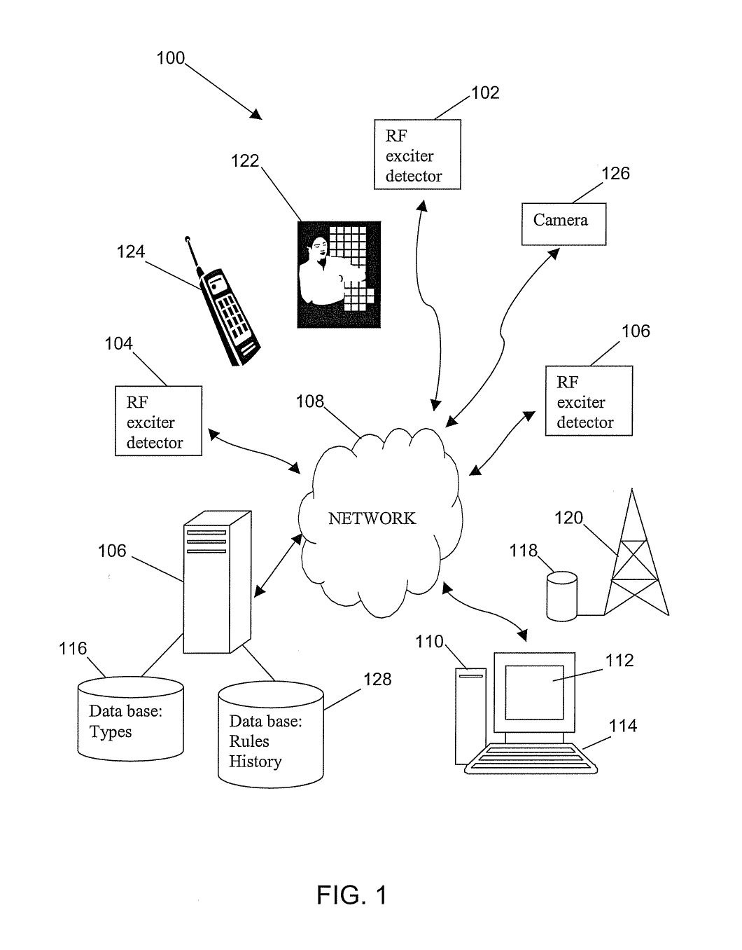

FIG. 1 is a block diagram of an exemplary system 100 for implementing the detection short range RF signals, such as RFID and Bluetooth enabled devices to discover, and potentially identify the presence of unexpected individuals, intruders, and threats according to embodiments of the invention. The system 100 includes remote devices 110, such as PCs, equipped with alphanumeric interfaces 114, such as keyboards, keypads, and touch screens, and displays 112 that facilitate graphical user interface (GUI) aspects for conducting transactions with a browser and associated plug-ins for carrying out aspects of embodiments of the invention. The displays 112 also provide outputs of views from cameras 120. The remote devices 110 may be wirelessly connected to a network 108. The network 108 may be any type of known network including a local area network (LAN), wide area network (WAN), wireless local area network (WLAN), global network (e.g., Internet), intranet, etc. with data/Internet capabilities as represented by server 106. Communication aspects of the network are represented by cellular base station 118 and antenna 120.

Each remote device 110 may be implemented using a general-purpose computer executing a computer program for carrying out the GUI described herein. The computer program may be resident on a storage medium local to the remote devices 110, or maybe stored on the server system 106 or cellular base station 110. The server system 106 may belong to a public service. The remote devices 110 may be coupled to the server system 106 through multiple networks (e.g., intranet and Internet) so that not all remote devices 110 are coupled to the server system 106 via the same network. The remote devices 110, and the server system 106 may be connected to the network 108 in a wireless fashion, and network 108 may be a wireless network. In a preferred embodiment, the network 108 is a LAN and each remote device 110 executes a user interface application (e.g., web browser) to contact the server system 106 through the network 108. Alternatively, the remote devices 110 may be implemented using a device programmed primarily for accessing network 108 such as a remote client. In an exemplary embodiment remote device 110 utilizes the network 108 to access embodiments of the security application that originates on server 106.

Continuing with FIG. 1, the server 106 is in electrical signal communication with a series of databases (116, 128) that contain a catalog of potential threat types 116, and rules for handling the threat types and their histories 128. A series of RF sensors (102, 104, 106) configured with exciters and detectors positioned throughout the area to be secured or monitored and are in electrical signal communication with the network 108. The RF exciter sends out a series of interrogation signals at various wavelengths to excite passive RFID tags 122 to return a signal. The detector portion of the RF sensor receives emissions from the RFID tag(s) 122, and other devices such as Bluetooth enabled devices 124. One or more cameras 126 may be in the system 100 to provide visual monitoring of areas of detected RF emissions. The one or more cameras 126 are in electrical signal communication with remote devices 110 and server 106 via the network 108.

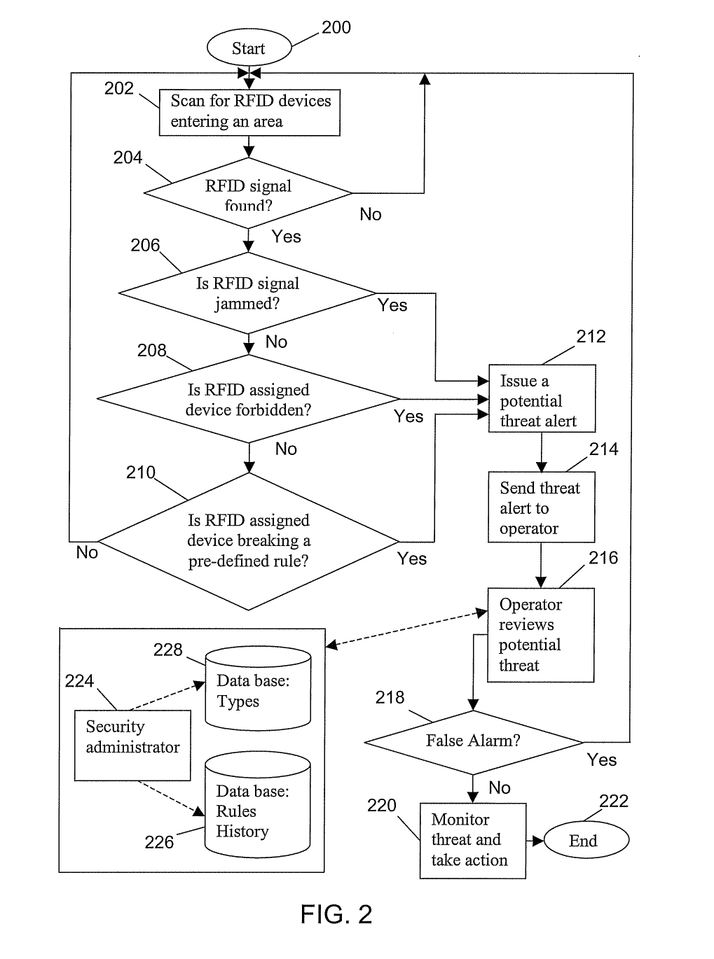

FIG. 2 is a flowchart illustrating a method for detecting short range RF signals, such as RFID enabled devices to discover, and potentially identify the presence of unexpected individuals, intruders, and threats. The process starts (block 200) by scanning for RFID devices entering an area to be monitored or secured (block 202). If an RFID signal is detected (decision block 204 is Yes), the following determinations are made. If the RFID signal is jammed (decision block 206 is Yes), the RFID assigned device is forbidden (decision block 208 is Yes), or the RFID assigned device is breaking a pre-defined rule (decision block 210 is Yes), a potential threat alert is issued (block 212), and sent to an operator (block 214). The operator reviews the potential threat (block 216) based on inputs from databases (226, 228) that catalog types of threats, their history, and rules for handling the threats. A security administrator 224 maintains the databases (226, 228). If the potential threat is a false alarm (decision block 218 is Yes) the system resumes scanning (block 202). However, if the potential detected threat is not a false alarm (decision block 218 is No), the threat is monitored and action is taken (block 220) and the process ends (block 222).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for monitoring for radio frequency (RF) signals to determine an unexpected presence, activity, or security threat, the method comprising:
scanning for RF signals;
detecting an RF signal;
determining at least one of the following: whether the RF signal is jammed, whether the RF signal is assigned to a device that is forbidden, and whether the RF signal is assigned to a device breaking one or more pre-defined rules;
sending a potential threat alert in response to the determining; and
wherein the one or more pre-defined rules are held in a database.

2. The method of claim 1, wherein the RF signals are radio frequency identification (RFID) signals.

3. The method of claim 1, wherein the RF signals are short range signals.

4. The method of claim 1, wherein camera views are prioritized in response to the detection of the RF signal.

5. The method of claim 1, wherein one or more of the following: RF signal triangulation and RF signal ranging are used to determine the position of the detected RF signal.
